(19) United States
(12) Patent Application Publication
(10) Pub. No.: US 2026/0139989 A1
(43) Pub. Date: May 21, 2026

(54) APPARATUS AND SYSTEM FOR TANK LEVEL SENSING

(71) Applicant: SCAD Technologies LLC, Winston-Salem, NC (US)

(72) Inventors: Michael Appolonia, Winston-Salem, NC (US); Stephen Humenick, St. Michaels, MD (US)

(21) Appl. No.: 18/951,029

(22) Filed: Nov. 18, 2024

(51) Int. Cl. G01F 25/20; G01F 23/263

(52) U.S. Cl. CPC G01F 25/20; G01F 23/266

(57) ABSTRACT

A tank level sensing system of the invention is used with a capacitive system having a pair of electrodes for capacitively coupling with a tank of fluid. A drive circuit provides a voltage drive signal to the drive electrode and a detector circuit is coupled with the sense electrode for detecting a sense voltage signal. A controller is coupled with the drive circuit and detector circuit to use the voltage drive signal and sense voltage signal for determining a fluid level of the tank. The controller varies the frequency of the voltage drive signal to the drive electrode through a plurality of frequencies and detects the sense voltage signal at the plurality of frequencies. The controller determines a plurality of endpoints at the plurality of different frequencies and selects one frequency for measurement. In one embodiment, the voltage drive signal is a sinusoidal voltage signal. In another embodiment, the plurality of frequencies includes base frequencies in a range of 1 kHz to 200 kHz that are offset with various dither frequencies. An output circuit outputs a signal reflective of the determined fluid level of the tank and provides selectable analog and digital output signals reflective of the determined fluid level of the tank.

### TECHNICAL FIELD

This invention is directed to an apparatus and system for monitoring the aqueous and liquid levels in a containment tank and particularly to such an apparatus and system that uses capacitance circuits for monitoring such levels.

### BACKGROUND OF THE INVENTION

In applications wherein liquids, such as water and water-based aqueous solutions, or other liquids, such as fuel, are stored in tanks, there is often the need to determine the level of the tank and assess its status relative to full or empty states. For example, recreational vehicles (RVs) often utilize a plurality of tanks for holding water and also holding waste or “grey” water. For the purposes of use of the water that is drawn from the tank, it is desirable to know how much is left in the tank. For grey water tanks that accumulate fluid, and that must be emptied regularly, it is desirable to know how much more fluid might be added in daily use until the tank needs to be emptied or drained.

To that end sensors and sensing systems are used with such tanks for determining their levels. Some such sensing systems operate inside of a tank, but because of their exposure to water and water solutions, they can degrade or foul over time and would need to be replaced. To address such issues, some systems may be sealed, such as in a plastic tube, to prevent fouling. One type of such sensing systems utilizes the measurement of capacitance between two electrodes that may be positioned inside the tank, for sealed applications, or between electrodes on the outside of the tank. For some tank applications, such as tanks made of plastic material, external capacitive electrodes and external sensing systems and sensors may be used. Specifically, using sensor electrode strips mounted externally on the tank's exterior wall, the capacitance may be measured between the electrode strips be a suitable sensor module that is electrically coupled to the electrode strips. The plastic tank wall and the level of the water, water solution or other fluid inside of the tank act as the dielectric between the electrode strips of the sensing system that are mounted on the exterior surface. As such, the fluid level affects the capacitance of the overall capacitive circuit that is created by the electrode strips. Accordingly, a measurement of the capacitance in such a circuit reflects the fluid level in the tank. The measured signal level may be scaled and displayed, showing levels between empty and full.

A particular problem with existing capacitive sensing systems is that, if it is an externally mounted system, the electrodes on the exterior of the wall as well as connecting wires/conductors, also act as antennas with respect to the signals used to excite the electrodes. Specifically, the oscillating currents in the signals, created by the sensing system electronics, are radiated from the electrode/antennas. For example, an oscillating square wave is usually used to excite one of the electrode strips and such a square wave includes rapid rise and fall time characteristics. Furthermore, due to the inefficiency of such square wave oscillator components, the driving power levels are relatively high. As such, many externally mounted capacitive sensing systems available produce a high level of electromagnetic interference (EMI). Such high EMI levels are then generally too high to pass various standards, such as the IEC/CISPR 11 and EN 55011 radiated field emission tests. Such standards are the predominant standards in Europe for receiving a CE marking.

Therefore, there is still a need in the industry for improvement in apparatuses and systems for sensing the fluid level of the tank and particularly in capacitive sensing systems that utilize externally mounted electrodes. Such a system should be able to address different size tanks. The above and other objects and advantages in accordance with the principles of the present invention shall be made apparent from the accompanying drawings and the description thereof.

### SUMMARY OF THE INVENTION

A tank level sensing system of the invention is used with a capacitive system that will generally include a pair of electrodes for capacitively coupling with a tank of fluid, including a drive electrode and a sense electrode. A drive circuit is coupled with the drive electrode for providing a voltage drive signal to the drive electrode and a detector circuit is coupled with the sense electrode for detecting a sense voltage signal from the sense electrode in response to the drive signal. A controller is coupled with the drive circuit and detector circuit and is configured for using the voltage drive signal and sense voltage signal for determining a fluid level of the tank. The controller varies the frequency of the voltage drive signal to the drive electrode through a plurality of frequencies and detects the sense voltage signal at the plurality of frequencies. The controller determines a plurality of endpoints at the plurality of different frequencies by detecting the sense voltage signal at each of the plurality of frequencies. In one embodiment, the voltage drive signal is a sinusoidal voltage signal. In another embodiment, the plurality of frequencies of the voltage drive signal might include a plurality of base frequencies and the controller is configured for varying each of the base frequencies with one or more dither frequency offset amounts during the detecting of the sense voltage signal at a particular base frequency. The base frequencies are in a range of 1 kHz to 200 kHz. An output circuit outputs a signal reflective of the determined fluid level of the tank and provides selectable analog and digital output signals reflective of the determined fluid level of the tank.

### BRIEF DESCRIPTION OF THE DRAWINGS

The accompanying drawings, which are incorporated in and constitute a part of this specification, illustrate embodiments of the invention and, together with the general description of the invention given above, and the detailed description given below, serve to explain the principles of the invention. Similar reference numerals are used to indicate similar features throughout the various figures of the drawings.

FIG. 1 is a schematic view of a system in accordance with an embodiment of the invention.

FIG. 1A is a schematic view of a system in accordance with another embodiment of the invention implementing the system mounted inside of a tank.

FIG. 1B is a cross sectional view of a system as in FIG. 1A in accordance with an embodiment of the invention.

FIG. 2 is a schematic view of components of a system in accordance with an embodiment of the invention as shown in FIG. 1.

FIG. 3 is a schematic view of processing components of a system in accordance with an embodiment of the invention as shown in FIG. 1.

FIG. 4 is a flow diagram of a portion of the process flow in accordance with an embodiment of the invention.

FIG. 5 is another flow diagram of another portion of the process flow in accordance with an embodiment of the invention.

FIG. 6 is another flow diagram of another portion of the process flow in accordance with an embodiment of the invention.

FIG. 7 is another flow diagram of another portion of the process flow in accordance with an embodiment of the invention.

### DETAILED DESCRIPTION OF EMBODIMENTS OF THE INVENTION

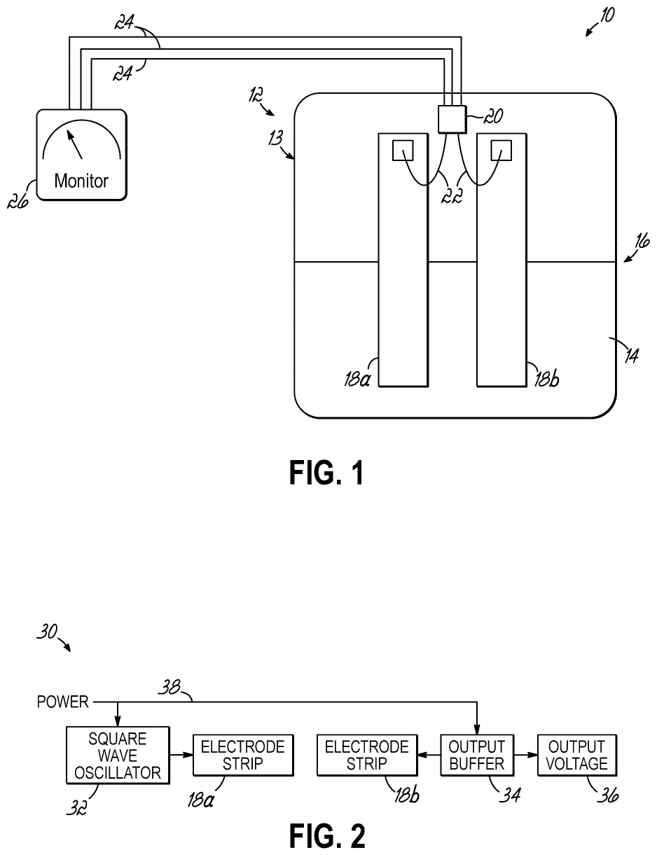

FIG. 1 is a schematic view of a system for sensing the level of water or another liquid in a tank. Specifically, system 10 incorporates a sensing system that is coupled to the exterior wall 13 of a tank 12. Generally, with such systems 10, the tank is made of a non-conductive plastic material, such as polyethylene. The tank 12, contains water 14 or some other aqueous solution, such as grey water, and defines a liquid level 16 inside the tank. Depending on the use of the tank, it is desirable to either have system 10 determine the level 16 remaining (such as water) to know how much is left, or to determine how much available capacity in the tank remains, such as for captured used grey water.

System 10 incorporates a pair of electrodes 18a, 18b that are mounted on the tank wall 13. The electrodes are typically in the form of elongated conductive metal strips that are mounted to the tank wall to be generally parallel with each other. The tank 12 and the water 14 in the tank act as the dielectric to a capacitive circuit, as would be understood by a person of ordinary skill in the art. The external sensor electrodes adhere to the outside of the tank and therefore cannot be fouled. The system 10 can sense through plastic and fiberglass tanks up to ½ inches thick up to 30 inches tall.

The electrodes are excited electrically with a drive signal from a sensor module 20 that is coupled by appropriate connections 22 with each electrode 18a, 18b. The circuitry of sensor module 22 is packaged so that it may be mounted to the tank in close proximity to electrodes 18a and 18b in order to minimize the length of any connecting wires and thus further minimize EMI. In one embodiment, the electrodes 18a and 18b may be in the form of electrode tapes that are adhered to the tank wall. The sensor module 22 is powered and coupled with a monitor display 26 through appropriate connections that provide DC power, ground and the a return analog or digital signal. The capacitance of the capacitive circuit would then be measured. That measured capacitance is reflective of the fluid level 16 in the tank 12.

FIG. 1A illustrates an alternative embodiment of a system 10a that might be used in accordance with the present invention. System 10a is inserted inside a tank 12 and contact the fluid 14 in the tank. The system 10a incorporates a pair of electrodes 18c, 18d that are sealed in a housing or tube 21 made of plastic or another suitable material to prevent contact of the electrodes and sensor module 20 with the fluid and thus prevent fouling. All other reference numerals are the same with FIG. 1 for common elements. FIG. 1B is a cross section of FIG. 1A showing the electrodes 18c, 18d and their positioning in the housing 21.

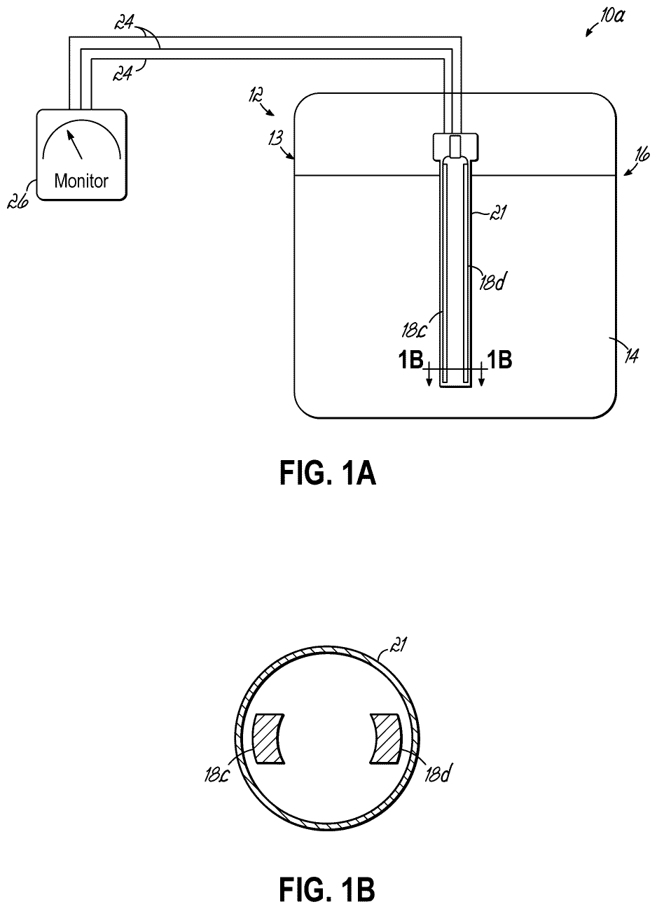

FIG. 2 is a simple schematic view of a typical circuit 30 of an existing sensing system. A drive signal generator, such as a square wave oscillator 32, is powered with an appropriate power signal and generates a drive signal to excite or drive one electrode strip 18a. Another electrode strip 18b is coupled with an output buffer circuit 34. The oscillator and buffer circuit are powered with appropriate power signals 38. The tank and the fluid level 16 in the tank determine the capacitance of the circuit 30. An output voltage signal 36, that is reflective of the capacitance of the circuit, is provided by the buffer circuit 34. That circuit may be used to display the measured capacitance between empty and full states for the tank 12. As noted, because of typical square wave excitation, as well as high power levels, in existing systems, they cause undesired levels of EMI interference.

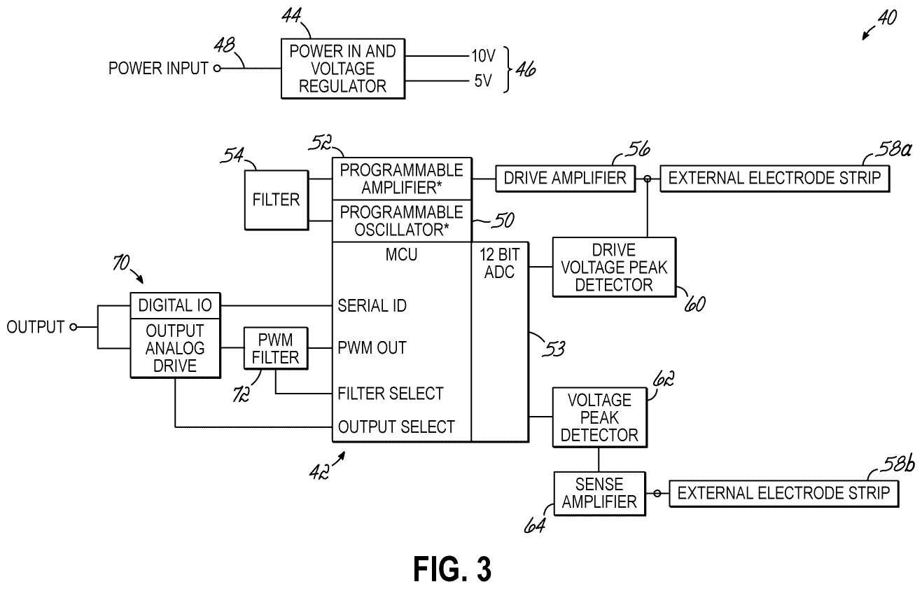

In accordance with embodiments of the invention, FIG. 3 illustrates an exemplary sensing system 40 of the invention that may be used with electrodes and a tank as illustrated in the Figures. System 40 incorporates a number of features, in accordance with the invention, for addressing shortcomings in the cited prior art. In accordance with one feature, the sensing system 40 uses a sine wave drive signal, in the form of a sine wave oscillation drive voltage signal. The sine wave significantly reduces the radiant harmonics provided to the electrodes 18a, 18b as opposed to the conventional square wave excitation circuit or other linear wave (e.g. sawtooth wave) with multiple harmonics, that are used in existing systems.

In accordance with another feature of the invention, the oscillating drive voltage is provided at a significantly reduced frequency. The frequency is an order of magnitude below what is generally provided as an excitation or drive signal in existing conventional tank sensing systems.

In accordance with another feature of the invention, the frequency of the drive signal for the electrodes is varied between a number of different base frequencies when determining a measurement range and endpoints for the EMPTY and FULL conditions in the measurement range. Then the most appropriate frequency with a valid range and endpoints is selected for the tank level measurement. Furthermore, on a periodic basis, the drive signal is varied or dithered in frequency by a certain percentage of the base frequency in order to reduce the radiated energy from the system at any one particular frequency. In still another feature, such a frequency variation is done randomly in the operation of the circuit.

The inventors have found that the combination of the various noted features greatly reduces the EMI and harmonics at the radio frequencies in the range that is typically tested by the FCC and CISPR11 agencies that set EMI standards. The inventive system has been tested for compliance with such applicable standards.

Turning to FIG. 3, the tank level sensing system 40 incorporates a microprocessor or microcontroller unit 42 that has non-volatile memory and runs the inventive system and processes a number of different inputs and outputs in accordance with features of the invention. For example, a Microchip PIC 16 chip from Microchip, Inc might be utilized. The components of system 40 are appropriately powered by a voltage regulator 44 that receives a power signal or input 48, such as a 10-20 Volt DC signal, such as from a power supply, and provides a desirable set of regulated voltage signals 46, such as at 5 Volts and 10 Volts in the illustrated embodiment. The regulator 44 also protects the MCU 42 from over-current, over-temperature and electro-static discharge (ESD) events. The MCU 42 controls all operations of the sensing system and further includes a programmable oscillator circuit or function 50, a programmable amplifier function 52, an analog to digital converter (ADC), such as a 12 bit ADC 53, as well as the necessary non-volatile memory (not shown) needed for operation.

The programmable oscillator 50 provides an appropriate drive signal, such as in the form of a voltage signal that is controlled by the the MCU 42 that controls both the voltage and frequency of the drive signals. The drive signal is then filtered by an appropriate filter circuit 54 and delivered to the programmable amplifier 52 for setting the level of the sinusoidal drive voltage. The filter circuit 54 filters out the non-sinusoidal components of the drive signal from the oscillator 50 and yields the desired sinusoidal drive voltage for the invention. The frequency of the sinusoidal drive signal provided by the oscillator 50, as well as the voltage level of the drive signal provided through the amplifier 52, are controlled appropriately by the MCU 42. The signal from the programmable amplifier circuit 52 is provided to a drive amplifier 56 that is also controlled by the MCU 42 and is coupled to one of the electrodes 58a to drive the electrode. A drive voltage peak detector circuit 60 is also coupled to the drive amplifier 56 and electrode 58a, such as an external electrode strip on the tank. The peak detector circuit 60 converts peak signal levels of the sinusoidal drive voltage to a DC voltage signal that may be measured by the ADC 53 in the MCU 42. The measured peak voltage is used by the MCU to control the drive voltage level through programmable amplifier 52.

The other external electrode 58b is coupled to a sense amplifier 64. A change in the tank fluid level changes the electrical capacitance across the electrodes 58a, 58b and the tank. This change in capacitance produces a sense signal that is a voltage signal that is measured and has a voltage level that is proportional to the change in capacitance in the electrode/tank/fluid level circuit reflected by the fullness or emptiness of the tank. The sense voltage signal level that is measured for a tank containing liquid will usually sit in a range between a voltage level or endpoint associated with a full tank and a voltage level or endpoint associated with an empty tank, as stored by the system, as explained herein. That measured or sense voltage signal is amplified by sense amplifier 64. The peak value of that signal is converted to a DC voltage signal, such as by the voltage peak detector 62, and the DC signal level is also measured by the analog-to-digital converter (ADC) 53 in the MCU 42. This provides a usable measurement of the capacitance that is, in turn, reflective of the level of fluid in the tank level. This may be then scaled appropriately by the MCU to provide a tank level output signal.

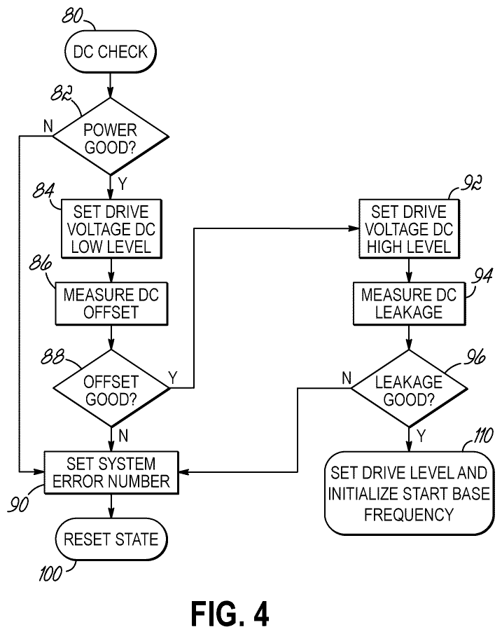

The software of the MCU operates to provide the desired sinusoidal and low frequency drive signals that are cycled in frequency among a plurality of base frequencies and are randomly varied in frequency in accordance with the invention. Turning to FIG. 4, as part of the program flow, an initial check of the DC levels present in the system may be provided to ensure accuracy and proper measurements in the system 10. Various DC resistive signal paths may develop across electrodes 58a, 58b due to contamination and environmental conditions. A DC Check program 80 of the invention therefore makes an initial determination of what DC resistive paths exist across the electrodes 58a, 58b and the level of the DC voltage of the circuit. An error is indicated if the DC voltage is too high or there is too much DC leakage in the circuit. If the level is small and manageable, the level will be subtracted by the MCU from the various measurements. First, as part of the DC Check 80, the power is checked to see that it is at a good level (block 82). If not, then a system error or error state is indicated (block 90). In the case of an analog only monitor system, the error condition is indicated or communicated with the monitor 26, such as with a predetermined error voltage signal at a particular level that is outside the normal voltage signal range. For example, the normal voltage signal range to an analog monitor may be reflected in an upper level for a full condition and a lower level for an empty condition. The error voltage signal might be below the empty tank level (e.g. 0.25 V). The monitor 26 will know that it is an error condition and may reflect the error, such as by lighting an error LED on the monitor. If the monitor is digital, the MCU 42 sends a digital code reflecting the error condition depending on the digital protocol. The present invention may be adapted as needed to be used by various different monitors and, as noted herein, provides the capability of delivering analog and digital outputs. Then, upon a detected or indicated error state, the system may reset. (block 100).

If the power levels are good, as indicated as a YES in block 82, the program proceeds to set a drive signal DC voltage for the electrodes 58a, 58b to a low level. (block 84) For example, the drive DC voltage might be set at 0 Volts DC. With the electrodes driven at the low level DC drive voltage, the DC voltage offset for the capacitive circuit is measured at that low level. (block 86) There will generally be some detectable offset voltage that exists. The measured DC offset voltage is then compared to a threshold voltage value to determine if the offset value is suitable. (block 88). If the level is not good or suitable, such as if the offset voltage is too high, then a system error or error state is indicated (block 90). Then, upon a detected or indicated error state, the system may reset. (block 100).

If the offset value is good, YES in block 88, the program proceeds to set a drive signal DC voltage for the electrodes 58a, 58b to a high level. (block 92) For example, the drive signal DC voltage might be set at 9.5 Volts DC. With the electrodes driven at the high level drive signal DC voltage, the DC leakage current for the capacitive circuit is measured to determine leakage currents from the electrodes 58a, 58b at that high level. (block 94). The measured DC leakage current is then compared to a threshold current value to determine if the leakage current value is suitable. (block 96). If the level is not good or suitable, such as if the leakage current is too high, then a system error or error state is indicated (block 90). Then, upon a detected or indicated error state, the system may reset a calibration timer as discussed herein. (block 100). If the level is suitable, the MCU initializes the starting base frequency of the drive signal for an automatic calibration process (block 110). The invention implements an automatic calibration process to determine a endpoints for the tank level range and also to determine a frequency at which the most accurate level reading can be achieved. Furthermore, the calibration process eliminates or discards various frequencies that do not provide sense amplitudes at proper levels as described herein. The automatic calibration process occurs on a regular interval that may be set to occur upon the expiration or timeout of an internal timer in the MCU 42.

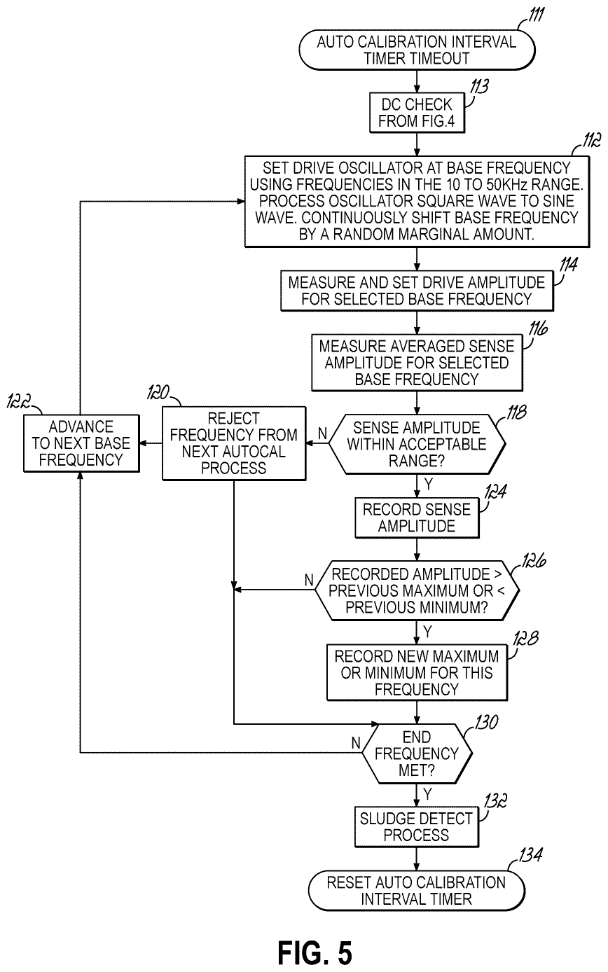

The flow in FIG. 4 is part of the program flow as set forth in FIG. 5 for the calibration process for the tank for ultimately determining the level of the tank in accordance with the present invention. The automatic calibration process (sometime referred to as autocalibration) will be initiated upon the timeout of a calibration timer so that calibration is automatic and can up date the system for varying tank conditions, such as when the tank is filled up or when the tank is completely empty. As discussed herein, those level condition end points for the EMPTY and FULL conditions can be periodically and automatically tested and stored to ensure that the most up to date EMPTY and FULL conditions are used by the invention to define the signal range for an accurate tank level reading. Turning to FIG. 5, if the auto calibration interval timer managed by the MCU times out (block 111), the DC Check might be made as noted and described with respect to FIG. 4 (block 113). For the calibration, the MCU initializes the starting base frequency and levels of the drive signal (block 112) through the programmable oscillator 50 and amplifier 52. A plurality of base frequency drive signals will be cycled through to define a plurality of sets of endpoints and ranges to be used by the invention. Generally, in accordance with one feature of the invention, the base frequency or frequencies that are used for the drive signals for calibration purposes and measurement is a frequency generally lower than what is conventional for existing systems. For example, the base frequency may be in the range of 1 kHz to 200 kHz. In the invention described herein, the base frequencies might be set in the range of 10 kHz to 50 kHz for the invention. Other frequencies in the noted broader range might also be used.

As part of the invention, measurements of the tank level are then taken at a number of different incremented frequencies in the range of the measurement base frequencies in order to calibrate the system and to determine the most appropriate frequency and associated endpoints to then use with the system for taking a level measurement. As noted, the invention is able to test out and calibrate the tank system with various base frequencies and to determine one or sets of endpoints to provide the most accurate frequency for a tank level measurement when it is requested. The invention also reduces the amount of EMI interference by dithering the base frequency selected for calibration by a random frequency amount. Measurements are made at a base frequency that is randomly dithered a small amount, and then the base frequency is incremented. Measurements are again made at the next base frequency and the various random dither frequency adjustments. The base frequencies are incremented and the measurements are made in a loop fashion until an end frequency or final frequency is reached or met. Furthermore, in accordance with another feature of the invention, the programmable oscillator 50 and filter 54 convert a square wave oscillation signal to a sine wave oscillation signal to form the drive signals as the various base frequencies. Therefore, the measurements are made using sine wave drive signals for further reducing EMI.

As noted, in accordance with still another feature of the invention, the MCU controls the oscillator 50 so that the base frequency of the drive signal is dithered randomly with a variable frequency offset to the base frequency. In one example, the offset might be in the range of 2-5 % of the base frequency. This reduces the radiated energy from the electrodes of the inventive system to reduce EMI issues. The use of, and measurements made at, various different base frequencies for the calibration and subsequent measurement allows for a wide range of tank sizes to be accommodated using the invention while maintaining a measured level signal with the highest possible accuracy and resolution. As discussed herein, the invention can select among the measurements to use the frequency that yields the best resolution and most accurate level measurement. An optimized frequency is found among the various base frequency measurements for subsequent measurement of the tank level. In accordance with one embodiment of the invention, the selected frequency is the highest frequency that yields valid EMPTY and FULL endpoints and a signal range to be used for then determining the tank level.

Accordingly for calibration in FIG. 5, per block 112, the MCU sets the drive oscillator circuit 50 at the base frequency. For example, a beginning frequency of 10 kHz might be used. A sine wave drive signal is generated by the oscillator 50 and filter 54 combination as described. The drive amplitude for the electrodes is then measured and set for a particular selected base frequency. (block 114) Specifically, the amplitude of the drive signal is measured, such as by drive voltage peak detector circuit 60. The various peaks of the measured drive signals are averaged to determine that the drive level is at the desired predetermined level for measurement. The predetermined level is adjustable in the MCU and may be set in non-volatile memory of the MCU. For example, it may be desirable to have the peak-to-peak voltage to be at a level around 9V. The level is accessed from memory by the MCU 42 which then adjusts the programmable amplifier 52 to set the drive voltage to an acceptable level. If the amplitude level is not acceptable, the amplitude is adjusted at the programmable amplifier circuit 52. Once that drive signal amplitude level is at a desirable level, it is set for the drive signal to drive the electrodes. (block 114)

The frequency dither process is also started by the MCU 42 through oscillator 50 for varying the drive signal frequency. To that end, a timer in the MCU might be set to control how often the particular base frequency is dithered or shifted by some amount in the measurement process. In one example, there are 8 different dithers or shifts although a greater or lesser number of shifts may be used. The frequency shifts add to or subtract from the base frequency. For example, the shifts might be +50 Hz, −30 Hz, +150 Hz, −75 Hz, . . . . The dither frequency amounts are added or subtracted from the base frequency of the drive signal to create the spread spectrum dither feature during the various measurements. The dither or frequency shift may occur at some cycle for the base frequency, such as every millisecond, for example, or at some set interval controlled by the MCU. Dithering is performed at each base frequency for the drive signal, during which multiple measurements are taken. The base frequency for each drive signal is slightly varied randomly, then the multiple measurements of the sense signal at the various or plurality of dithered base frequencies are averaged by the controller to define essentially one measurement reading for each base frequency.

At a particular drive signal base frequency, the sense signal voltage at the other electrode is measured at the selected base frequency with dither adjustments, such as using the sense voltage peak detector circuit 62 (block 116). If the average sense voltage from the various base and dither frequencies is in a good or acceptable range, that is, it is above some minimum level but is not overdriven or overloaded, the average sense voltage from the various measurements that are measured may be recorded (block 124). However, before it would be recorded, the level of the measured sense voltage is evaluated against one or more thresholds by the MCU to ensure that the sense voltage of the electrode at the particular base frequency is within the range that can be handled by the ADC 53 of the MCU. Usually the ADC 53 will work in a range of a lower voltage around 0 V, such as 0.1 V for example, up to some maximum upper voltage value, such as 4 V, for example. The MCU evaluates the amplitude of the sense signal to ensure it is in the desirable range for the ADC and MCU (block 118).

In accordance with another aspect of the invention, the calibration process of the invention, as it cycles through the plurality of base frequencies, will discard certain base frequencies from the measurement protocol if they do not yield sense signal amplitude measurements in acceptable levels. For example, again referring to FIG. 5, a determination is made to see if the amplitude of the sense signal is in the desirable range or is out of range (block 118). If not in range, that selected base frequency is rejected from the subsequent or next automatic calibration processes. (block 120). That is, the invention will use a plurality of different base frequencies for the automatic calibration process to set valid EMPTY and FULL endpoints and associated ranges, but will learn in that process that certain frequencies do not yield valid endpoints and ranges for the tank and system and will then avoid those base frequencies that do not yield usable signal levels and ranges in the measurement process. If the measurement at the particular frequency is not usable or is outside the acceptable range, then that selected base frequency is rejected and the calibration process advances to the next base frequency. (block 122). In one embodiment, a test may be made, as in block 130 on whether the current frequency is an end or last frequency and that all of the base frequencies have been cycled through and/or measured. To that end, flow from block 120 may progress through block 130 before advancing to block 122 and then incrementing to the next frequency.

If measurements have been made at the final base frequency, the process flow advances out of the calibration process of FIG. 5 as described herein. If the final frequency has not been measured, the frequency is advanced and the process returns to block 112 so measurements are taken at the next base frequency. That is, the drive signal frequency is advanced or incremented to the next base frequency. For example, it might be varied from 10 kHz to 20 kHz, for example, and the programmable oscillator 50 appropriately adjusted to provide the new drive signals with appropriate dither frequency adjustments so that measurements may be made at the new base frequency. (block 112). The process advances through the various base frequencies in that way and measurements are made at the plurality of base frequencies to build up a plurality of endpoints and signal ranges for use in determining the tank level. In one particular embodiment of the invention, 6 base frequencies are used for calibration and establishment of endpoints and ranges for the various base frequencies. For example, 20, 25, 30, 35, 40, 45 kHz base frequencies might be used.

The measurement and recordation for the automatic calibration may occur on a cyclical basis, such as every 20 to 120 seconds, for example. The cycle may be selectable through an appropriate autocalibration interval timer in the MCU depending on the application and tank used. For example, if the application is known, the measurement cycle for the calibration might be a factory setting for the system. In that way, the invention cycles through all of the sense voltage signal peaks and measurements for the electrodes at the various base frequencies and for the various dither frequency adjustments to a particular base frequency. Some measurements are recorded and some might be rejected as out of range as disclosed. The ADC of the MCU measures the peak values of the measurements at the different frequencies and the MCU averages out all of the peak values from the base frequency and the different dither frequencies to arrive at a measured sense signal voltage value. The measured sense signal voltage value for a particular base frequency that is within the suitable range is then recorded and stored by the MCU. (block 124)

In accordance with another feature of the invention, with each calibration process a determination is made on whether the inventive sensing system should store one or more measurements made as new endpoints for representing FULL and EMPTY conditions of the tank. That is, depending on conditions in the tank, the sensing system of the invention will update the endpoints that are representative of what is a FULL condition and what is and EMPTY condition for a particular base frequency. In that way, through the automatic calibration process, and the repeated filling and emptying in the use of the tank, the system can arrive at steady state conditions wherein the most accurate EMPTY and FULL conditions may be stored for future reference. With the automatic calibration feature of the invention, the tank level measurements are made on a continuous basis and the measurements are compared over time to store the maximum and minimum measurements as endpoints in memory as the FULL and EMPTY tank values to define a range for a particular base frequency drive signal. The series of measurements are used and if the measurements are found to be within a small deviation of each other by the MCU, then the mean value of the measurements will be used and compared to previous stored measurements for FULL and EMPTY endpoints. If the measured value is at a level above a previously recorded tank level maximum value (the FULL value), then that new maximum value will replace the old FULL value and will be stored in non-volatile memory of the MCU as the new FULL value. Similarly, if the measured value is found to be at a level below a previously recorded tank level minimum value (the EMPTY value), then that new minimum value will replace the old EMPTY value and will be stored in non-volatile memory of the MCU as the new EMPTY value.

Accordingly, in accordance with one feature of the invention, with the autocalibration feature enabled, as the measurements are taken over time, they are compared to previous recorded values and used to adjust the FULL and EMPTY endpoint voltages. The more the automatic calibration is run and the system used, the more accurate it is. EMPTY and FULL values are stored for each of the base frequency values at which the measurements are made and which yield valid signal levels as discussed herein. The autocalibration process and the taking of measurements at the varying frequencies runs at any tank level. Over time, as the tank is used in accordance with the invention, the automatic calibration process will see different tank levels. As the tank is filled in use and then emptied in use, the invention arrives at the most accurate and calibrated FULL and EMPTY endpoint values.

Those endpoint signal values and voltages may then be used to provide a representative tank level measurement when an operator requests a level reading for the tank. To that end, referring to FIG. 5, a test is made at block 126 to determine if the recorded sense amplitude was above or below the current EMPTY/FULL endpoints of the system. That is, if the recorded amplitude was greater than a previous maximum amplitude (or FULL condition) or the recorded amplitude was less than previous minimum amplitude (or EMPTY condition), then that new endpoint is recorded and will replace the current value as an endpoint, or a new EMPTY or FULL condition signal level (block 128). In that way, the calibration process is always updating the range for measurement to ensure that it has the most accurate readings of the true tank level.

Again, as noted herein, with each frequency that is addressed and measured, a test may be made to determine if the final base frequency or the end frequency had been met or selected (block 130). If not, the process flow may proceed to the next base frequency (block 122) and the process loop of FIG. 5 begins again to take new sense voltage amplitude measurements at another base frequency with appropriate dither frequency adjustments over the set measurement cycle to get the series of measurements to be averaged and stored or discarded. The use of the plurality of various different base frequencies ensures the best voltage measurements for the sense amplifier 64 and sense voltage peak detector 62 are found for the accuracy of the system.

Once the various measured and recorded sense voltages are obtained and recorded through each of the base frequencies, and the last or end base frequency is met, the program progresses out of the auto calibration process, such as to blocks 132, 134 as shown in FIG. 5. The invention may proceed to a condition where the auto calibration interval timer is reset and the system is ready to receive a command, such as a command to provide a tank level measurement. (block 134) In accordance with another feature of the invention, the sensing system may be able to adjust the measurements to account for a build up of sediment or sludge in the tank that may detrimentally affect the accuracy of the level measurements (block 132) as shown in FIG. 5.

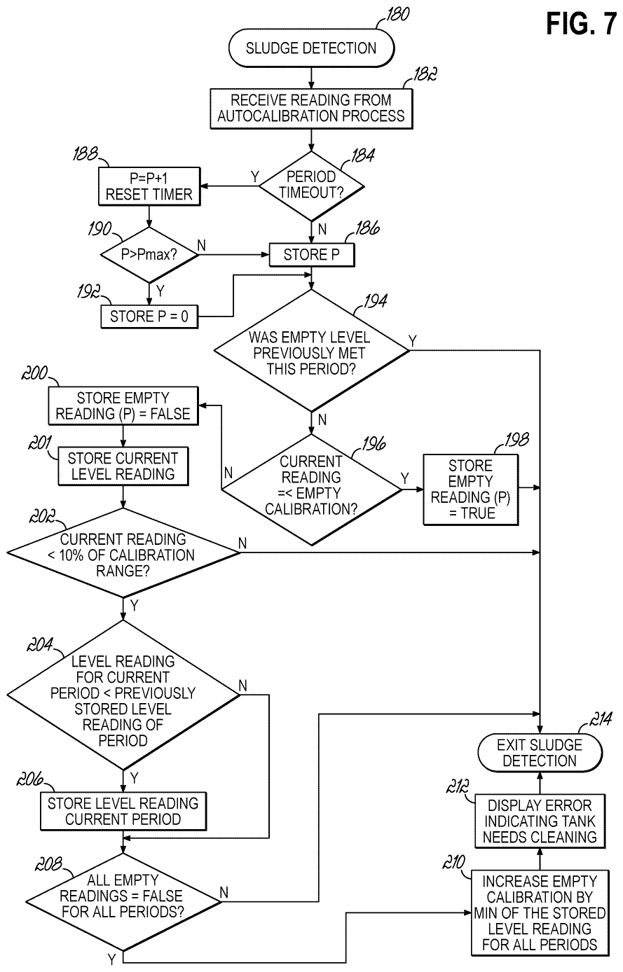

Referring to FIG. 7, a sludge/sediment detection feature of the invention may be used to adjust for changing tank conditions. Specifically, the inventive sensing system keeps track of various auto calibration readings over periods of time to determine if the EMPTY level of the tank was reached or if the true or most accurate empty level can no longer be reached because of a build up of sludge/sediment in the tank. Period timers, such as on the order of a month, are kept to take readings at certain longer time periods (over several months) to determine a variation in tank conditions. Referring to FIG. 7, the sludge detection process begins (block 180) after calibration (see FIG. 5, block 132) when calibration has taken place and calibration measurements, such as EMPTY and FULL measurements, are available to the inventive system. The reading from the auto calibration process that is reflective of an EMPTY endpoint that associated with the selected frequency (e.g., the highest frequency of the plurality of base frequencies) is received (block 182) for analysis. A determination is made in the MCU on whether the current period has expired (block 184), for example, if the period is a month long, has a month elapsed since the last period was noted?. The MCU runs an appropriate period timer for such a process. If not, the current period P is stored as the period associated with the recently measured conditions in the auto calibration process (block 186). However, if the period has timed out or elapsed, a new period is noted and the specific current period P is appropriately incremented (P+1) to a new period. The period timer of the MCU is also reset to count for the new period P+1. There may be set in the MCU a maximum number of test periods Pmax to elapse for the sludge detection process before the entire process is started again. To that end, if the period is incremented to the next period, a test may be made (block 190) on whether the maximum period Pmax has been exceeded. That is, if the current incremented period would go beyond the maximum amount Pmax, the period could be set to 0 or to another beginning point in the process. If the maximum has not been reached, the process flow proceeds to block 186 to store the new incremented period P as the currently period associated with the recently measured conditions in the auto calibration process (block 186).

Once the period of interest P for the measurement has been determined, a test is made to see if the EMPTY level was ever reached in that current period (block 194). If there is sludge or sediment in the tank of any significance, this will affect the tank and may prevent it from ever reaching the previously determined EMPTY level, that was set when the tank was newer or had not yet developed a sludge condition. If the empty level had been reached during the current period denoting a true or YES condition for the test of block 194, then that means that sludge or build up has not significantly affected the tank sensing system in that period P to a degree that it changes that EMPTY level condition. In that case, the sludge detection process may be exited per the flow path of FIG. 7 and block 214.

However if the EMPTY level had not been reached denoting a false or NO condition for the test of block 194 for the current period P, that may indicate that a change in tank conditions might have occurred that prevents the previous empty level measurement. A test can then be made on whether the current reading made from the auto calibration process was actually an EMPTY level condition reading or was maybe even less than an EMPTY level condition reading. If that is the case and YES for block 196, that means that an EMPTY level condition was indeed reached for that period. (block 196) The EMPTY reading for that period P is stored, such as a TRUE condition for the period P (block 198). In that way, when the sludge detection process of FIG. 7 is entered again, there will be a stored and noted EMPTY condition for the system during that period P and the process flow will proceed, through block 194, out of the sludge detection process (block 214). However, if an EMPTY level was not reached per block 196, the EMPTY reading condition for that period P is stored as a FALSE condition for the period (block 200). The current level reading is also stored (block 201) to provide a benchmark to further determine if a sludge condition exists.

A test may then be made to determine if the current reading is too high of a reading to reflect a sludge condition. For example, in an embodiment of the invention, if the current reading is significantly higher than some low percentage of the calibration signal range, there is some other condition that exists and it would not be a sludge condition. For example, if the tank was never fully emptied after the calibration process was previously completed, the current reading may be greater than some percentage of the calibration range. To that end, a determination is made by the program on whether the current reading is at the lower end of the calibration range (ie lower end of the EMPTY to FULL range) (block 202). For example, a determination may be made as to whether the current reading is below 10% (or some other set percentage) of the calibration range. If it is not (NO for block 202) then the reading is high enough that sludge detection is exited (block 214) as shown in the path of FIG. 7.

If however the current reading is on the lower end of the range (YES for block 202) then a determination may be made on whether that measured level reading for the current period P is lower or less than what had been stored as the previous level reading for that period P (block 204). That is, would there be a new low or EMPTY level reading for the period P? If not (NO of block 204), then the currently stored level reading would remain intact. If it is lower (True of block 204) then the current level reading would be stored as the new level reading for the current period.

In accordance with one feature of the invention, a test is made for the full duration of all the periods on whether the EMPTY stage was ever reached for the tank. That is, were all the EMPTY readings for the all the periods a FALSE condition, meaning that the tank never reached an EMPTY condition (see blocks 194, 196, 200)? If so, as indicated by a YES condition for block 208, then that would indicate a sludge condition that is keeping the tank from going to the full EMPTY state. If not, indicated by a NO condition with block 208, then an empty condition had been reached within the periods and the sludge detection process could be exited (block 214). If an EMPTY state had not been reached, the process flow progresses to block 210 wherein the EMPTY calibration point would be increased by some amount to account for the sludge condition. Specifically, as illustrated, the EMPTY calibration point might be increased by the smallest or minimum stored level reading for all of the periods measured (block 210). This would then adjust the calibration range to improve the level reading in the sludge condition. Additionally, an ERROR message might be displayed on an appropriate monitor or display to indicate to a user of that condition and that the tank needs cleaning. (block 212). The sludge detection process could then be exited (block 214). In that way, the present invention can determine a more accurate reading for the tank level and take into account, over time, the degradation of the tank and the measurement process due to a build up of sludge or settlement.

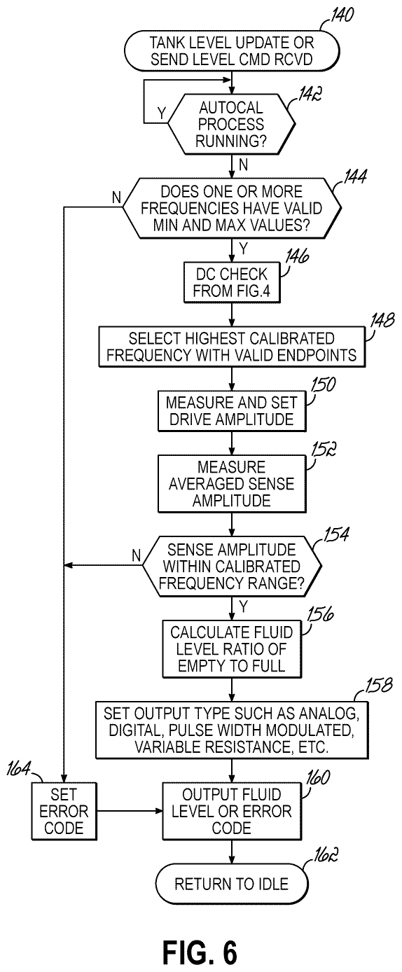

Using the various calibrated end points for EMPTY and FULL and the range defined thereby, the invention can provide an indication of the current tank level for a user so that they can monitor the times when tanks may need to be refilled or emptied. To that end, referring to FIG. 6, the process flow for providing an indication of tank level may begin based upon a tank level update, that occurs on a periodic basis in the invention regardless of user interaction, or an actual or receipt of a command to send a current tank level reading (block 140). The system will determine if the automatic calibration process is running and if so, the controller will wait until that process is complete (block 142). Once the process knows that any current automatic calibration process is complete, then a check is made to determine if that calibration process (as reflected in FIG. 5 program flow) yielded one or more, but at least one, base frequency measurement with valid minimum or maximum values that are reflective of EMPTY and FULL conditions. In order to take a tank level reading and compare it to a range between EMPTY and FULL the endpoints have to be established.

As discussed herein, the automatic calibration process is carried out by the MCU 42 at various intervals to determine and store in memory the end point sense voltage amplitude levels for the EMPTY tank and FULL tank conditions without user intervention. The full and empty amplitude levels then are used to ratio the measured sense amplitude levels at the various base frequencies for determining the level of the tank. For example, a sense voltage amplitude level that falls at the 75^{th} percentile of the range of sense voltage levels defined by the endpoints would indicate that a tank is ¾ of the way full.

If there are no frequency measurement from the various base frequencies used in the automatic calibration process, the invention will indicate that there is an error. Referring to FIG. 6 an error code is set (block 164) and them may be reported rather than a tank level (block 160). If there are one or more frequency measurements that yield valid end points, the process flow proceeds. In one embodiment, another DC level check and discussed in the FIG. 4 process flow may be performed in case there may have been some other change in the system (block 146).

In accordance with another feature of the invention, the sensing system selects a measurement frequency to use from among the plurality of base frequencies at which the calibration was performed. In one embodiment of the invention, the highest calibrated frequency that has valid measured and stored endpoints (block 148) and therefore a defined range is used. As discussed with respect to the process flow of FIG. 5, various base frequencies are used during the automatic calibration process and while one or more frequencies may be discarded, there may be one or more frequencies that also yield valid endpoint measurements that are stored. The invention, in accordance with another feature of the invention, uses the highest valid calibrated frequency that has valid endpoints. That is, the maximum base frequency is selected at which the MCU and program have both calibrated measurements and also a valid measured sense amplitude level. This maximum base frequency that meets those conditions, as determined by the MCU, will have the greatest differential voltage signal levels between the EMPTY level and FULL level. Therefore, that frequency will have the greatest resolution for comparison against a measured tank level for determining what condition the tank is in between those end levels.

That frequency is then used to make a tank level measurement. Referring to block 150, the drive amplitude for the electrodes is then measured and set for a particular selected base frequency as earlier discussed with calibration. Specifically, the amplitude of the drive signal is measured, such as by drive voltage peak detector circuit 60 and determined to be at the desired predetermined level for measurement. The predetermined level is adjustable in the MCU to set the drive voltage to an acceptable level to drive the electrodes.

Then, the sense amplitude for the electrodes at the selected drive signal frequency is measured (block 150). Measurements are taken at that drive frequency as adjusted by the various dither frequency offsets. Presumably, depending on the tank level, that measured value will be between the valid EMPTY and FULL endpoints. A check is made to ensure that the measured sense amplitude is withing the calibrated frequency range (block 152). If for some reason it is not, the program sets an error code (block 164) and the error status is reported or output (block 160). If a valid sense amplitude is measured, then the calibrated endpoint measurements and measured sense amplitude level are used to calculate the tank level (block 156) The program run by the MCU uses a ratio of the measured sense amplitude level to the range of signal levels defined by the calibrated endpoint levels to determine the tank level as reflecting a percentage between EMPTY and FULL conditions. That is, the measured sense signal would generally have a value that falls above the EMPTY level value and below the FULL level value and that is used to reflect the fluid level of the tank.

Then the measured value and percentage may be displayed (block 160). In accordance with another feature of the invention, the type of display or monitor and the necessary outputs needed for such a display/monitor may be selected by the user of the invention, as set forth in block 158 of FIG. 6. The invention, in one embodiment, provides a unique method to select the desired output type for the monitor. This will instruct or select the output setting as shown in block 158 of FIG. 6. In one embodiment, the sensing system 40 may select the output type by powering the system ON while the output wire is grounded and then powering the system OFF. Depending on the time duration that the system is powered ON with the output grounded, the user may select the desired output type. Specifically, the user may select the output type, that might be selected from an analog output, a digital output, a pulse width modulated output, a variable resistance output or another appropriate format based on the use of the tank and the application and the monitor 26. The MCU 42 has a number of selectable output formats as shown in FIG. 3 that may be coupled with an appropriate display device 26 to indicate the tank level. The output types of the system may include, but are not limited to, variable voltage, variable resistance, pulse width modulation, and custom and industry standard digital methods and protocols. In accordance with that feature of the invention, the inventive system may be used with a number of monitors. The unique ability to select the different output types allows the user the flexibility to interface with a variety of analog and digital monitors or monitoring systems. In another embodiment of the invention, for setting the type of output mode, a digital user interface might be used to interface with the sensing system for selecting if the output mode is analog or digital. The user interface would generally be part of the monitoring system. Digital systems with the appropriate software can have multiple sensors on the same bus cable simplifying system wiring. The digital system during installation and setup might a unique address to each sensor or sensing system, such as the inventive sensing system described herein. The digital system may then request level readings, error status, or send commands to the sensing system.

Referring again to FIG. 6, after a level value is computed (block 156) and it is known the type of output that is desired, the level value command is output (block 160). If the inventive system is being used with a digital monitor that requests a level report, the output circuitry 70 (see FIG. 3) will send digital codes through a serial output of the MCU. By selecting a digital output and turning off the analog output, the MCU may communicate with the display/controller using serial I/O in various formats, such as half duplex, NRZ, ASCII character format, for example. The digital codes could include a digital code verifying the request, an error code if there is any, which can be followed by an analog voltage or a digital code proportional to the tank level.

The output circuitry has suitable analog features and outputs to be used by an analog monitor. Using the measured sensed voltage and calibration constants, the MCU calculates a PWM signal which is filtered to provide a DC voltage in a range of 0-5V. A desired range for a particular application may be set in the MCU. For example, a PWM output may be provided for the analog output. A raw PWM signal may be provided to the monitor 26 or a selectable PWM filter 72 might be selected through the MCU to filter the PWM signal to provide a DC level to the monitor. A user may select a filter or no filter. The combination of digital and analog communication allows a digital monitor to have multiple sensors on a single wire. If the inventive sensing system is being used on a monitor that only accepts an analog output, the output level will change to reflect the fluid level of the tank. Upon completion of the output level update, either by the user request or periodic sensing system update, the inventive sensing system will reset all the internal timers and repeat the cycle for making measurements.

While the present invention has been illustrated by the description of one or more embodiments thereof, and while the embodiments have been described in considerable detail, they are not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants'general inventive concept.

What is claimed is:

1. A tank level sensing system for determining fluid levels in a tank comprising:
electrodes configured for capacitively coupling with a tank of fluid, including a drive electrode and a sense electrode;
a drive circuit coupled with the drive electrode for providing a drive signal to the drive electrode;
a detector circuit coupled with the sense electrode for detecting a sense signal level from the sense electrode in response to the drive signal;
a controller coupled with the drive circuit and detector circuit, the controller configured for using the sense signal level for determining endpoints for a range of signal levels, the endpoints including a FULL endpoint and an EMPTY endpoint for reflecting fluid levels of the tank;
the controller further configured for varying the frequency of the voltage drive signal to the drive electrode through a plurality of frequencies and determining a plurality of endpoints at the plurality of different frequencies by detecting the sense voltage signal at each of the plurality of frequencies.

2. The tank level sensing system of claim 1, the controller further configured for using a set of endpoints at a selected frequency that is selected from the plurality of frequencies, defining the range of signal levels for the set of endpoints, detecting a sense signal level at the selected frequency and comparing the sense signal level to the range of signal levels for the set of endpoints for determining the fluid level in a tank.

3. The tank level sensing system of claim 2, the controller further configured for evaluating at least one sense signal level from the sense electrode when determining endpoints for a range of signal levels at a particular frequency of the plurality of frequencies, and comparing the at least one sense level signal against a threshold and, based on the comparison, rejecting the frequency from being the selected frequency for determining the fluid level in a tank.

4. The tank level sensing system of claim 1 wherein the voltage drive signal is a sinusoidal voltage signal.

5. The tank level sensing system of claim 1 wherein the plurality of frequencies of the voltage drive signal includes a plurality of base frequencies, the controller further configured for varying each of the base frequencies of the drive signal with a dither frequency offset amount during the detecting of the sense voltage signal at a particular base frequency.

6. The tank level sensing system of claim 5 wherein the controller is further configured for varying each of the base frequencies with a plurality of dither frequency offset amounts for each base frequency during the detecting of the sense voltage signal at that particular base frequency and detecting multiple sense signals at the varied base frequencies.

7. The tank level sensing system of claim 1 wherein the plurality of frequencies of the voltage drive signal include a plurality of base frequencies, the base frequencies being the range of 1 kHz to 200 kHz.

8. The tank level sensing system of claim 5 wherein, the controller is further configured for varying each of the base frequencies with a plurality of dither frequency offset amounts in the range of 2-5 % of the base frequency.

9. The tank level sensing system of claim 1 further comprising an output circuit for outputting a signal reflective of the determined fluid level of the tank, the output circuit providing selectable analog and digital output signals reflective of the determined fluid level of the tank.

10. A tank level sensing system for use with electrodes for capacitively coupling with a tank of fluid, including a drive electrode and a sense electrode, the sensing system comprising;
a drive circuit configured for being coupled with the drive electrode for providing a drive signal to the drive electrode;
a detector circuit configured for being coupled with the sense electrode for detecting a sense signal from the sense electrode in response to the drive signal;
a controller coupled with the drive circuit and detector circuit, the controller configured for using the sense signal level for determining endpoints for a range of signal levels, the endpoints including a FULL endpoint and an EMPTY endpoint for a fluid level of the tank;
the controller further configured for varying the frequency of the voltage drive signal to the drive electrode through a plurality of frequencies and determining a plurality of endpoints at the plurality of different frequencies by detecting the sense voltage signal at each of the plurality of frequencies.

11. The tank level sensing system of claim 10 the controller further configured for using a set of endpoints at a selected frequency that is selected from the plurality of frequencies, defining the range of signal levels for the set of endpoints, detecting a sense signal level at the selected frequency and comparing the sense signal level to the range of signal levels for the set of endpoints for determining the fluid level in a tank.

12. The tank level sensing system of claim 11, the controller further configured for evaluating at least one sense signal level from the sense electrode when determining endpoints for a range of signal levels at a frequency of the plurality of frequencies, and comparing the at least one sense level signal against a threshold and, based on the comparison, rejecting the frequency from being the selected frequency for determining the fluid level in a tank.

13. The tank level sensing system of claim 10 wherein the voltage drive signal is a sinusoidal voltage signal.

14. The tank level sensing system of claim 10 wherein the plurality of frequencies of the voltage drive signal includes a plurality of base frequencies, the controller further configured for varying each of the base frequencies of the drive signal with a dither frequency offset amount during the detecting of the sense voltage signal at a particular base frequency.

15. The tank level sensing system of claim 14 wherein the controller is further configured for varying each of the base frequencies with a plurality of dither frequency offset amounts for each base frequency during the detecting of the sense voltage signal at that particular base frequency and detecting multiple sense signals at the varied base frequencies.

16. The tank level sensing system of claim 10 wherein the plurality of frequencies of the voltage drive signal include a plurality of base frequencies, the base frequencies being the range of 1 kHz to 200 kHz.

17. The tank level sensing system of claim 15 wherein, the controller is further configured for varying each of the base frequencies with a plurality of dither frequency offset amounts in the range of 2-5 % of the base frequency.

18. The tank level sensing system of claim 10 further comprising an output circuit for outputting a signal reflective of the determined fluid level of the tank, the output circuit providing selectable analog and digital output signals reflective of the determined fluid level of the tank.

19. A method of measuring the level in a tank of fluid comprising:
positioning electrodes for capacitively coupling with a tank of fluid, including a drive electrode and a sense electrode;
providing a drive signal to the drive electrode;
detecting a sense signal from the sense electrode in response to the drive signal;
using the sense signal level for determining endpoints for a range of signal levels, the endpoints including a FULL endpoint and an EMPTY endpoint for a fluid level of the tank;
varying the frequency of the voltage drive signal to the drive electrode through a plurality of frequencies and determining a plurality of endpoints at different frequencies by and detecting the sense voltage signal at each of the plurality of frequencies.

20. The method of claim 19 further comprising using a set of endpoints at a selected frequency of the plurality of frequencies, defining the range of signal levels for the set of endpoints, detecting a sense signal level at the selected frequency and comparing the sense signal level to the range of signal levels for the set of endpoints for determining the fluid level in a tank.

21. The tank level sensing system of claim 20 further comprising evaluating at least one sense signal level from the sense electrode when determining endpoints for a range of signal levels at a frequency of the of the plurality of frequencies, and comparing the at least one sense level signal against a threshold, based on the comparison rejecting the frequency from being the selected frequency for determining the fluid level in a tank.

22. The method of claim 19 further comprising providing a sinusoidal voltage signal as the voltage drive signal

23. The method of claim 19 wherein the plurality of frequencies of the voltage drive signal includes a plurality of base frequencies, the method further comprising varying each of the base frequencies of the drive signal with a dither frequency offset amount during the detecting of the sense voltage signal at a particular base frequency.

24. The method of claim 23 further comprising varying each of the base frequencies with a plurality of dither frequency offset amounts for each base frequency during the detecting of the sense voltage signal at that particular base frequency and detecting multiple sense signals at the varied base frequencies.

25. The method of claim 19 wherein the plurality of frequencies of the voltage drive signal includes a plurality of base frequencies, the base frequencies being in the range of 1 kHz to 200 kHz.

26. The method of claim 19 further comprising providing an output signal reflective of the determined fluid level of the tank, and selecting one of analog and digital output signals reflective of the determined fluid level of the tank.
